(19) United States
(12) Patent Application Publication
(10) Pub. No.: US 2013/0022738 A1
(43) Pub. Date: Jan. 24, 2013

(54) LIQUID CRYSTAL COATING APPARATUS AND METHOD, AND SUPPORTING STAGE

(71) Applicants: Mingfeng Deng, Shenzhen (CN); Yizhuang Zhuang, Shenzhen (CN); Songxian Wen, Shenzhen (CN)

(72) Inventors: Mingfeng Deng, Shenzhen (CN); Yizhuang Zhuang, Shenzhen (CN); Songxian Wen, Shenzhen (CN)

(73) Assignee: Shenzhen China Star Optoelectronics Technology Co. Ltd., Shenzhen (CN)

(21) Appl. No.: 13/376,384

(22) PCT Filed: Sep. 28, 2011
(86) PCT No.: PCT/CN11/80309

§ 371 Date: Dec. 6, 2011

(30) Foreign Application Priority Data
Jul. 20, 2011 (CN) 201110203960.4

(51) Int. Cl. B05D 5/06; B25B 11/00; B23Q 1/64; B05B 1/00; B05B 15/00

(52) U.S. Cl. 427/162; 118/57; 118/712; 269/55; 269/21

(57) ABSTRACT

A liquid crystal coating apparatus includes a liquid crystal spraying head for coating a liquid crystal material on a color filter (CF) substrate with a sealant to allow the liquid crystal material to be coated within an area surrounded by the sealant; and a supporting stage for accommodating and fixing the CF substrate. The supporting stage is provided with a vibrating mechanism for driving the CF substrate to mechanically vibrate continuously so that the liquid crystal material can become uniformly diffused quickly. In the present disclosure, the vibrating mechanism is activated after coating of the liquid crystal material is completed to drive the CF substrate to mechanically vibrate continuously; and is deactivated once the liquid crystal material is diffused uniformly. Therefore, the liquid crystal material can become uniformly diffused quickly, which guarantees the displaying performance of the final products and improves the production efficiency.

### BACKGROUND

1. Technical Field

The present disclosure relates to liquid crystal displaying technologies, and more particularly, to a liquid crystal coating apparatus, a liquid crystal coating method and a supporting stage.

2. Description of Related Art

Liquid crystal displays (LCDs) are widely used in various electronic products. Most of the LCDs are backlight LCDs including a liquid crystal panel and a backlight module. The liquid crystal panel consists of a thin film transistor (TFT) substrate and a color filter (CF) substrate with a liquid crystal layer being encapsulated therebetween.

During the assembling process of a liquid crystal panel, a liquid crystal material is filled and sealed between the TFT substrate and the CF substrate. In the prior art, there are two ways of filling the liquid crystal material between the TFT substrate and the CF substrate, i.e., the way of injection and the way of one drop filling (ODF).

However, the aforesaid ways of filling a liquid crystal material fail to satisfy requirements of large-size panels because of a long filling time. The conventional ODF process is as follows: spraying the liquid crystal material through a nozzle onto a CF substrate provided with a sealant in such a way that the liquid crystal material is restricted within an area surrounded by the sealant. Because it is unable to effectively control the spraying rate and the quantity of the liquid crystal material during the spraying process, the resulting liquid crystal film formed on the CF substrate tends to have a non-uniform thickness, which may compromise the displaying performance of the final product. Meanwhile, the time necessary for the liquid crystal material sprayed onto the CF substrate to diffuse around freely to form a uniform liquid crystal film is too long, which decreases the production efficiency of LCDs.

### BRIEF SUMMARY

A primary objective of the present disclosure is to provide a liquid crystal coating apparatus, a liquid crystal coating method and a supporting stage, which allow for quick and uniform diffusion of the coated liquid crystal material so as to guarantee the displaying performance of the final products and improve the production efficiency by shortening the time necessary for the liquid crystal coating process.

The present disclosure provides a liquid crystal coating apparatus, which includes: a liquid crystal spraying head, being adapted to coat a liquid crystal material on a color filter (CF) substrate provided with a sealant in such a way that the liquid crystal material is coated within an area surrounded by the sealant; and a supporting stage, being adapted to accommodate and fix the CF substrate, wherein the supporting stage is provided with a vibrating mechanism adapted to drive the CF substrate to mechanically vibrate continuously so that the liquid crystal material coated on the CF substrate can become uniformly diffused quickly.

Preferably, the vibrating mechanism is disposed at a central position on a lower surface of the supporting stage.

Preferably, at least two said vibrating mechanisms are disposed uniformly on the lower surface of the supporting stage.

Preferably, the supporting stage is provided with a plurality of vacuum nozzles, and the CF substrate is adsorbed onto the supporting stage by means of the vacuum nozzles.

Preferably, the vibrating mechanism is adapted to drive the CF substrate to vibrate in a direction perpendicular to the CF substrate.

Preferably, the vibrating mechanism is adapted to drive the CF substrate to vibrate in two directions orthogonal to each other alternately within a plane parallel to the CF substrate.

Preferably, the liquid crystal coating apparatus further includes a monitoring mechanism and a controlling mechanism, wherein the monitoring mechanism is adapted to monitor a status of the liquid crystal material after coating of the liquid crystal material is completed, and the controlling mechanism is adapted to activate the vibrating mechanism after coating of the liquid crystal material is completed and to determine whether to deactivate the vibrating mechanism according to the status of the liquid crystal material.

Preferably, the monitoring mechanism is provided with an image capturing module configured to capture an image of the CF substrate after coating of the liquid crystal material is completed.

Preferably, the controlling mechanism is adapted to deactivate the vibrating mechanism if the liquid crystal material coated on the CF substrate is in a uniform status and keep the vibrating mechanism activated if the liquid crystal material coated on the CF substrate is in a non-uniform status.

The present disclosure further provides a supporting stage for accommodating and fixing a CF substrate, wherein the supporting stage is provided with a vibrating mechanism for driving the CF substrate to mechanically vibrate continuously so that a liquid crystal material coated on the CF substrate can become uniformly diffused quickly.

Preferably, the vibrating mechanism is disposed at a central position on a lower surface of the supporting stage.

Preferably, at least two said vibrating mechanisms are disposed uniformly on the lower surface of the supporting stage.

Preferably, the supporting stage is provided with a plurality of vacuum nozzles, and the CF substrate is adsorbed onto the supporting stage by means of the vacuum nozzles.

Preferably, the vibrating mechanism is adapted to drive the CF substrate to vibrate in a direction perpendicular to the CF substrate.

Preferably, the vibrating mechanism is adapted to drive the CF substrate to vibrate in two directions orthogonal to each other alternately within a plane parallel to the CF substrate.

The present disclosure further provides a liquid crystal coating method, which includes the following steps of:

spraying a liquid crystal material on a CF substrate; and

driving the CF substrate to mechanically vibrate continuously so that the liquid crystal material coated on the CF substrate can become uniformly diffused quickly.

Preferably, the step of driving the CF substrate to mechanically vibrate continuously includes:

driving the CF substrate to vibrate in a direction perpendicular to the CF substrate.

Preferably, the step of driving the CF substrate to mechanically vibrate continuously includes:

driving the CF substrate to vibrate in two directions orthogonal to each other alternately within a plane parallel to the CF substrate.

Preferably, the liquid crystal coating method further includes the following steps of:

monitoring whether the liquid crystal material coated on the CF substrate is uniform; and

if the liquid crystal material coated on the CF substrate is uniform, then stopping driving the CF substrate to vibrate, and otherwise, continuing to drive the CF substrate to vibrate.

According to the liquid crystal coating apparatus, the liquid crystal coating method and the supporting stage of the present disclosure, the vibrating mechanism is activated after coating of the liquid crystal material is completed so that the CF substrate can be driven by the vibrating mechanism to mechanically vibrate continuously; and once the liquid crystal material is diffused uniformly, the vibrating mechanism is deactivated. In this way, the liquid crystal material can become uniformly diffused quickly. This can guarantee the displaying performance of the final products and improve the production efficiency by shortening the time necessary for the liquid crystal coating process.

### BRIEF DESCRIPTION OF THE DRAWINGS

FIG. 1 is a schematic structural view of a liquid crystal coating apparatus according to an embodiment the present disclosure;

FIG. 2 is a schematic structural view of a CF substrate on which a liquid crystal material has been coated by the liquid crystal coating apparatus of the present disclosure;

FIG. 3 is a schematic structural view of a supporting stage according to an embodiment of the present disclosure;

FIG. 4 is a schematic structural view of the supporting stage according to another embodiment of the present disclosure; and

FIG. 5 is a flowchart diagram of a liquid crystal coating method according to an embodiment of the present disclosure.

Hereinafter, implementations, functional features and advantages of the present disclosure will be further described with reference to embodiments thereof and the attached drawings.

### DETAILED DESCRIPTION

It shall be understood that, the embodiments described herein are only intended to illustrate but not to limit the present invention.

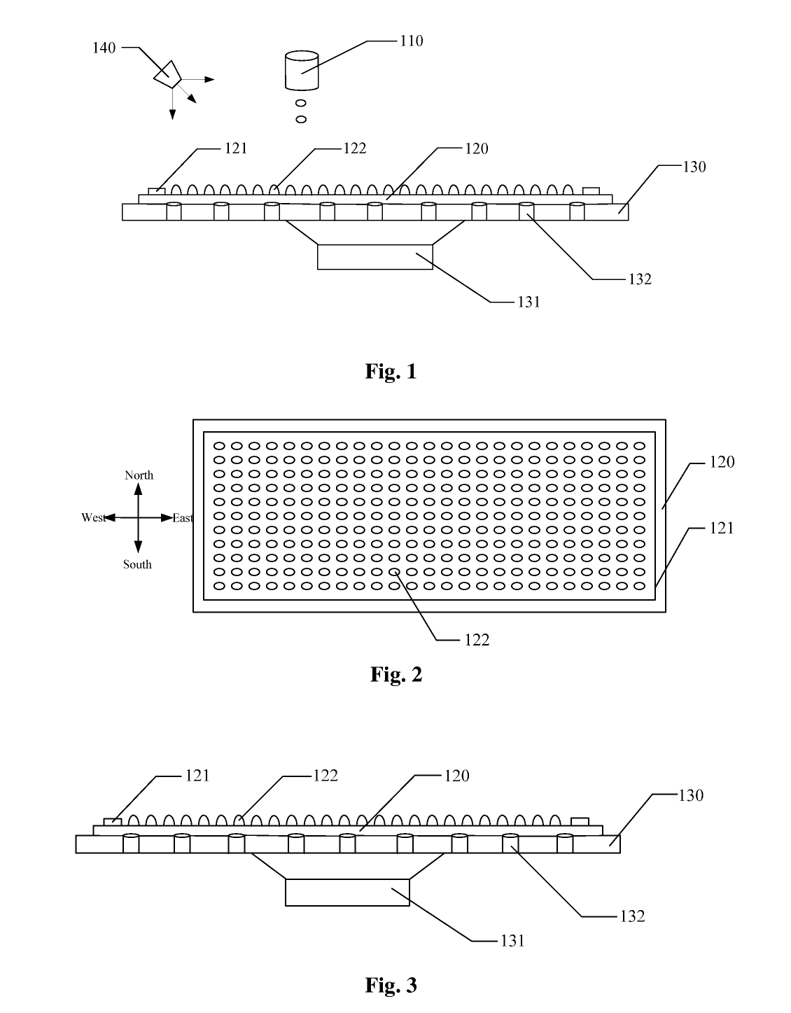

Referring to FIG. 1, there is shown a liquid crystal coating apparatus according to an embodiment of the present disclosure. The liquid crystal coating apparatus includes: a liquid crystal spraying head 110, being adapted to coat a liquid crystal material 122 on a color filter (CF) substrate 120 provided with a sealant 121 in such a way that the liquid crystal material 122 is coated within an area surrounded by the sealant 121; and a supporting stage 130, being adapted to accommodate and fix the CF substrate 120. The supporting stage 130 is provided with a vibrating mechanism 131 adapted to drive the CF substrate 120 to mechanically vibrate continuously so that the liquid crystal material 122 coated on the CF substrate 120 can become uniformly diffused quickly.

Further, the vibrating mechanism 131 is disposed at a central position on a lower surface of the supporting stage 130.

Further, at least two said vibrating mechanisms 131 are disposed uniformly on the lower surface of the supporting stage 130. For example, a number of said vibrating mechanisms 131 are uniformly disposed at a fixed interval in a lengthwise direction of the supporting stage 130 on the lower surface of the supporting stage 130. This can ensure that a force is applied uniformly on the CF substrate 120 and the liquid crystal material 122 coated on the CF substrate 120 becomes uniformly diffused.

Further, in the aforesaid embodiment of the liquid crystal coating apparatus, specifically, the vibrating mechanism 131 is adapted to drive the CF substrate 120 to vibrate in a direction perpendicular to the CF substrate 120, or to drive the CF substrate 120 to vibrate in two directions orthogonal to each other alternately at a plane parallel to the CF substrate 120. Referring to FIG. 2, there is shown a schematic structural view of the CF substrate 120 on which the liquid crystal material 122 has been coated by the liquid crystal coating apparatus of the present disclosure. If one of the vibration directions is an east-west direction, then the other vibration direction is a south-north direction. In this embodiment, by driving the CF substrate 120 to vibrate in the two directions orthogonal to each other alternately at the plane parallel to the CF substrate 120, it can be ensured that the CF substrate 120 experiences consistent vibrations in different horizontal directions so that the liquid crystal material 122 can diffuse around consistently to achieve the effect of quick and uniform diffusion.

Further, in the aforesaid embodiment of the liquid crystal coating apparatus, the liquid crystal coating apparatus further includes a monitoring mechanism 140 and a controlling mechanism (not shown). The monitoring mechanism 140 is adapted to monitor a status of the liquid crystal material 122 coated on the CF substrate 120 after coating of the liquid crystal material is completed. The controlling mechanism is adapted to activate the vibrating mechanism 131 after coating of the liquid crystal material 122 on the CF substrate 120 is completed and to determine whether to deactivate the vibrating mechanism 131 according to the status of the liquid crystal material 122 coated on the CF substrate 120.

Further, in the aforesaid embodiment of the liquid crystal coating apparatus, the liquid crystal material 122 has a uniform status and a non-uniform status.

Specifically, the controlling mechanism is adapted to deactivate the vibrating mechanism 131 if the liquid crystal material 122 coated on the CF substrate 120 is in the uniform status and keep the vibrating mechanism 131 activated if the liquid crystal material 122 coated on the CF substrate 120 is in the non-uniform status.

In the aforesaid embodiment of the liquid crystal coating apparatus, when the liquid crystal material 122 coated on the CF substrate 120 is in the uniform status and the controlling mechanism has deactivated the vibrating mechanism 131, the coating process of the liquid crystal material 122 is completed. Then, the process for manufacturing liquid crystal displays (LCDs) may proceed to a next step.

Further, in the aforesaid embodiment of the liquid crystal coating apparatus, the monitoring mechanism 140 is provided with an image capturing module configured to capture an image of the CF substrate after coating of the liquid crystal material is completed. The image capturing module includes a charge-coupled device (CCD) camera, which is located above the supporting stage 130 and configured to capture an image of the CF substrate 120 after coating of the liquid crystal material 122 is completed. That is, the monitoring mechanism 140 captures an image of the CF substrate 120 in real time by means of the CCD camera after coating of the liquid crystal material 122 is completed, performs a gray scale comparison processing on the image that is captured in real time, and determines whether the current liquid crystal material 122 is uniform according to the gray scale comparison processing result. If the current liquid crystal material 122 is in the uniform status, a command is sent to the controlling mechanism, then the controlling mechanism deactivates the vibrating mechanism 131 according to the command

Further, in the aforesaid embodiment of the liquid crystal coating apparatus, the supporting stage 130 is provided with a plurality of vacuum nozzles 132, and the CF substrate 120 is adsorbed onto the supporting stage 130 fixedly by means of the vacuum nozzles 132.

In this embodiment, the vibrating mechanism 131 is activated after coating of the liquid crystal material 122 is completed so that the CF substrate 120 can be driven by the vibrating mechanism 131 to vibrate continuously; and once the liquid crystal material 122 is diffused uniformly, the vibrating mechanism 131 is deactivated. In this way, the liquid crystal material 122 can become uniformly diffused quickly. This can guarantee the displaying performance of final products and improve production efficiency by shortening the time necessary for the liquid crystal coating process.

Referring to FIG. 3, there is shown a supporting stage according to an embodiment of the present disclosure. The supporting stage 130 is adapted to accommodate and fix a CF substrate 120. The supporting stage 130 is provided with a vibrating mechanism 131 for driving the CF substrate 120 to mechanically vibrate continuously so that a liquid crystal material 122 coated on the CF substrate 120 can become uniformly diffused quickly. The CF substrate is provided with a sealant 121, and the liquid crystal material 122 is coated within an area surrounded by the sealant 121 in the liquid crystal coating process.

Further, the vibrating mechanism 131 is disposed at a central position on a lower surface of the supporting stage 130.

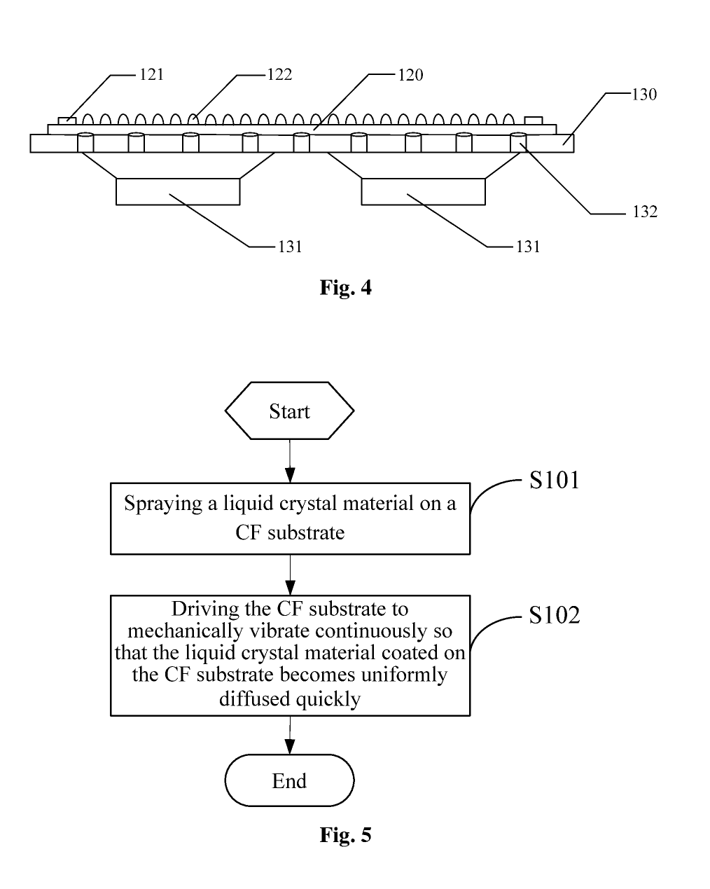

Further, referring to FIG. 4, at least two said vibrating mechanisms 131 are disposed uniformly on the lower surface of the supporting stage 130. For example, a number of said vibrating mechanisms 131 are uniformly disposed at a fixed interval in a lengthwise direction of the supporting stage 130 on the lower surface of the supporting stage 130. This can ensure that a force is applied uniformly on the CF substrate 120 and the liquid crystal material 122 coated on the CF substrate 120 becomes uniformly diffused.

Further, the supporting stage 130 is provided with a plurality of vacuum nozzles 132, and the CF substrate 120 is adsorbed onto the supporting stage 130 fixedly by means of the vacuum nozzles 132.

Further, in the aforesaid embodiment of the supporting stage 130, the vibrating mechanism 131 is adapted to drive the CF substrate 120 to vibrate in a direction perpendicular to the CF substrate 120 or to drive the CF substrate 120 to vibrate in two directions orthogonal to each other alternately within a plane parallel to the CF substrate 120. Referring to FIG. 2, there is shown a schematic structural view of the CF substrate 120 on which the liquid crystal material 122 has been coated by the liquid crystal coating apparatus of the present disclosure. If one of the vibration directions is an east-west direction, and the other vibration direction is a south-north direction. In this embodiment, by driving the CF substrate 120 to vibrate in the two directions orthogonal to each other alternately within the plane parallel to the CF substrate 120, it can be ensured that the CF substrate 120 experiences consistent vibrations in different horizontal directions so that the liquid crystal material 122 can diffuse around consistently to achieve the effect of quick and uniform diffusion.

According to this embodiment of the supporting stage 130 of the present disclosure, the CF substrate 120 is driven by the vibrating mechanism 131 to vibrate continuously. In this way, the liquid crystal material 122 can become uniformly diffused quickly. This can guarantee the displaying performance of the final products and improve the production efficiency by shortening the time necessary for the liquid crystal coating process.

Referring to FIG. 5, there is shown a liquid crystal coating method according to an embodiment of the present disclosure. The liquid crystal coating method includes the following steps of:

a step S101: spraying a liquid crystal material on a CF substrate; and

a step S102: driving the CF substrate to mechanically vibrate continuously so that the liquid crystal material coated on the CF substrate can become uniformly diffused quickly.

In this embodiment, after coating of the liquid crystal material on the CF substrate is completed by the liquid crystal spraying head, the vibrating mechanism is activated by the controlling mechanism immediately so that the CF substrate can be driven by the vibrating mechanism to mechanically vibrate continuously. Thereby, the liquid crystal material coated on the CF substrate can become uniformly diffused quickly through vibration of the CF substrate. In addition, the CF substrate is adsorbed onto the supporting stage by means of the vacuum nozzles before the liquid crystal material is coated on the CF substrate; and then the liquid crystal material is coated by the liquid crystal spraying head. The liquid crystal material is coated through use of a common coating technique in the prior art, i.e., by spraying the liquid crystal material through a nozzle of a sprayer onto the CF substrate (within the range enclosed by the plastic frame).

Further, in the aforesaid embodiment of the liquid crystal coating method, the step of driving the CF substrate to mechanically vibrate continuously includes: driving the CF substrate to vibrate in a direction perpendicular to the CF substrate; or driving the CF substrate to vibrate in two directions orthogonal to each other alternately within a plane parallel to the CF substrate. Referring to FIG. 2, there is shown a schematic structural view of the CF substrate on which the liquid crystal material 122 has been coated by the liquid crystal coating apparatus of the present disclosure. When the CF substrate is driven to vibrate in two directions orthogonal to each other alternately within a plane parallel to the CF substrate, if one of the vibration directions is an east-west direction, then the other vibration direction is a south-north direction. In this embodiment, by driving the CF substrate to vibrate in the two directions orthogonal to each other alternately within the plane parallel to the CF substrate, it can be ensured that the CF substrate experiences consistent vibrations in different horizontal directions so that the liquid crystal material can diffuse around consistently to achieve the effect of quick and uniform diffusion.

Further, in the aforesaid embodiment of the liquid crystal coating method, the liquid crystal coating method further includes the following steps of: monitoring whether the liquid crystal material coated on the CF substrate is uniform after coating of the liquid crystal material is completed on the CF substrate; and if the liquid crystal material coated on the CF substrate is uniform, then stopping driving the CF substrate to vibrate, and otherwise, continuing to drive the CF substrate to vibrate. That is, after coating of the liquid crystal material on the CF substrate is completed, a status of the liquid crystal material coated on the CF substrate is monitored by the monitoring mechanism. If it is found that the liquid crystal material coated on the CF substrate is in the uniform status, then a command is sent to the controlling mechanism to notify the controlling mechanism to deactivate the vibrating mechanism. If it is found that the liquid crystal material coated on the CF substrate is in the non-uniform status, then no command is sent and, in this case, the controlling mechanism keeps the vibrating mechanism activated.

According to this embodiment of the liquid crystal coating method of the present disclosure, the vibrating mechanism is activated after coating of the liquid crystal material is completed so that the CF substrate can be driven by the vibrating mechanism to vibrate continuously; and once the liquid crystal material is diffused uniformly, the vibrating mechanism is deactivated. In this way, the liquid crystal material can become uniformly diffused quickly. This can guarantee the displaying performance of the final products and improve the production efficiency by shortening the time necessary for the liquid crystal coating process.

What described above are only preferred embodiments of the present invention but are not intended to limit the scope of the present invention. Accordingly, any equivalent structural or process flow modifications that are made on basis of the specification and the attached drawings or any direct or indirect applications in other technical fields shall also fall within the scope of the present invention.

What is claimed is:

1. A liquid crystal coating apparatus, comprising:
a liquid crystal spraying head, being adapted to coat a liquid crystal material on a color filter (CF) substrate provided with a sealant in such a way that the liquid crystal material is coated within an area surrounded by the sealant; and
a supporting stage, being adapted to accommodate and fix the CF substrate;
wherein the supporting stage is provided with a vibrating mechanism adapted to drive the CF substrate to mechanically vibrate continuously so that the liquid crystal material coated on the CF substrate can become uniformly diffused quickly.

2. The liquid crystal coating apparatus of claim 1, wherein the vibrating mechanism is disposed at a central position on a lower surface of the supporting stage.

3. The liquid crystal coating apparatus of claim 1, wherein at least two said vibrating mechanisms are disposed uniformly on the lower surface of the supporting stage.

4. The liquid crystal coating apparatus of claim 1, wherein the supporting stage is provided with a plurality of vacuum nozzles, and the CF substrate is adsorbed onto the supporting stage fixedly by means of the vacuum nozzles.

5. The liquid crystal coating apparatus of claim 1, wherein the vibrating mechanism is adapted to drive the CF substrate to vibrate in a direction perpendicular to the CF substrate.

6. The liquid crystal coating apparatus of claim 1, wherein the vibrating mechanism is adapted to drive the CF substrate to vibrate in two directions orthogonal to each other alternately within a plane parallel to the CF substrate.

7. The liquid crystal coating apparatus of claim 1 further comprises a monitoring mechanism and a controlling mechanism, the monitoring mechanism is adapted to monitor a status of the liquid crystal material after coating of the liquid crystal material is completed, and the controlling mechanism is adapted to activate the vibrating mechanism after coating of the liquid crystal material is completed and to determine whether to deactivate the vibrating mechanism according to the status of the liquid crystal material.

8. The liquid crystal coating apparatus of claim 7, wherein the monitoring mechanism is provided with an image capturing module configured to capture an image of the CF substrate after coating of the liquid crystal material is completed.

9. The liquid crystal coating apparatus of claim 7, wherein the controlling mechanism is adapted to deactivate the vibrating mechanism if the liquid crystal material is in a uniform status and keep the vibrating mechanism activated if the liquid crystal material is in a non-uniform status.

10. A supporting stage for accommodating and fixing a CF substrate, wherein the supporting stage is provided with a vibrating mechanism for driving the CF substrate to mechanically vibrate continuously so that a liquid crystal material coated on the CF substrate can become uniformly diffused quickly.

11. The supporting stage of claim 10, wherein the vibrating mechanism is disposed at a central position on a lower surface of the supporting stage.

12. The supporting stage of claim 10, wherein at least two said vibrating mechanisms are disposed uniformly on the lower surface of the supporting stage.

13. The supporting stage of claim 10, wherein the supporting stage is provided with a plurality of vacuum nozzles, and the CF substrate is adsorbed onto the supporting stage fixedly by means of the vacuum nozzles.

14. The supporting stage of claim 10, wherein the vibrating mechanism is adapted to drive the CF substrate to vibrate in a direction perpendicular to the CF substrate.

15. The supporting stage of claim 10, wherein the vibrating mechanism is adapted to drive the CF substrate to vibrate in two directions orthogonal to each other alternately within a plane parallel to the CF substrate.

16. A liquid crystal coating method, comprising the following steps of:
spraying a liquid crystal material on a CF substrate; and
driving the CF substrate to mechanically vibrate continuously so that the liquid crystal material coated on the CF substrate can become uniformly diffused quickly.

17. The liquid crystal coating method of claim 16, wherein the step of driving the CF substrate to mechanically vibrate continuously comprises:
driving the CF substrate to vibrate in a direction perpendicular to the CF substrate.

18. The liquid crystal coating method of claim 16, wherein the step of driving the CF substrate to mechanically vibrate continuously comprises:
driving the CF substrate to vibrate in two directions orthogonal to each other alternately within a plane parallel to the CF substrate.

19. The liquid crystal coating method of claim 16 further comprises the following steps of:
monitoring whether the liquid crystal material coated on the CF substrate is uniform; and
stopping driving the CF substrate to vibrate if the liquid crystal material coated on the CF substrate is uniform, and otherwise, continuing to drive the CF substrate to vibrate.
